(19) United States
(12) Patent Application Publication
(10) Pub. No.: US 2013/0298377 A1
(43) Pub. Date: Nov. 14, 2013

(54) Flexible Cord or Hose Handling Device and Method

(71) Applicant: Robert B. Stewart, Crawfordville, FL (US)

(72) Inventor: Robert B. Stewart, Crawfordville, FL (US)

(21) Appl. No.: 13/468,056

(22) Filed: May 10, 2012

(51) Int. Cl. B23P 17/04

(52) U.S. Cl. 29/428

(57) ABSTRACT

A hose guide for guiding a hose over the edge of a roof or similar structure. The hose guide includes a base. A pivot mount is attached to the base. A pulley assembly is pivotally attached to the pivot mount. The pulley assembly includes a freely rotating pulley, which is bounded on at least three sides by a first lateral wall, a second lateral wall, and a gate. The gate may be selectively opened to allow a mid point of a hose to be placed on the pulley. The gate is then closed to capture the hose in the pulley housing.

### CROSS-REFERENCES TO RELATED APPLICATIONS

Not Applicable.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of construction equipment. More specifically, the invention comprises a cord or hose guide which safely feeds cords or hoses over the edge of a structure.

2. Description of the Related Art

Modern construction employs a wide variety. Of power tools. Most of these tools receive energy from an air hose or an electrical cord. The present invention is equally applicable to hoses or cords. However, a hose is used consistently in the examples provided. In the field of roofing, for example, nails are most commonly driven through shingles and into the decking using pneumatic nail guns driven by an air hose. The air hose runs from a compressor residing on the ground up to one or more nail guns being operated on the roof.

FIG. 1 illustrates a common scenario. Nail gun 16 is being used on roof 10. Compressor 20 is resting on the ground hear the structure. Air hose 18 must be passed around eave 12 and over edge 14 in order to reach the roof. The free-hanging portion of the air hose imposes a significant load on edge 14. The edge itself is typically formed by a slightly overhanging piece of the lowest shingle. The shingle is not designed to withstand this load and may fold or break.

FIG. 2 shows a perspective view of the same scenario. The reader will of course realize that the nail gun does not remain in one position on the roof. The roofer moves laterally as he affixes a row of shingles. Thus, air hose 18 is dragged back and forth along edge 14 as indicated by the double-ended arrow. The motion of the hose along the edge tends to damage the shingles. As most shingles are highly abrasive, the dragging of the hose along the edge may also damage the hose.

The prior art approach introduces other problems as well. When the user needs more air hose—such as, when he needs to move further up the roof—the use must pull hard enough on the hose to overcome the friction of the hose scraping over the shingle edge. This action further damages the shingles and worsens the abrasion damage to the air hose itself.

Accordingly, it is desirable to produce a hose or cord handling system which prevents the destructive interaction with the edge of the roof. The present invention provides such a solution.

### BRIEF SUMMARY OF THE INVENTION

The present invention comprises a hose guide for guiding a hose over the edge of a roof or similar structure. The hose guide includes a base. A pivot mount is attached to the base. A pulley assembly is pivotally attached to the pivot mount. The pulley assembly includes a freely rotating pulley, which is bounded on at least three sides by a first lateral wall, a second lateral wall, and a gate. The gate may be selectively opened to allow a mid-point of a hose to be placed on the pulley. The gate is then closed to capture the hose in the pulley housing.

The pulley divides the hose into a free hanging portion and a roof portion. The pulley assembly is positioned so that the free hanging portion of the hose hangs clear of the edge and does not contact the edge. When the user pulls on the hose the pulley rotates to minimize friction as more hose transitions over the edge and onto the roof. As the user moves laterally the pulley assembly pivots. In this way the user may move about the roof in a much less impeded fashion.

### BRIEF DESCRIPTION OF THE SEVERAL VIEWS OF THE DRAWINGS

FIG. 1 is an elevation view, showing an air hose leading from a compressor on the ground to a nail gun on a roof.

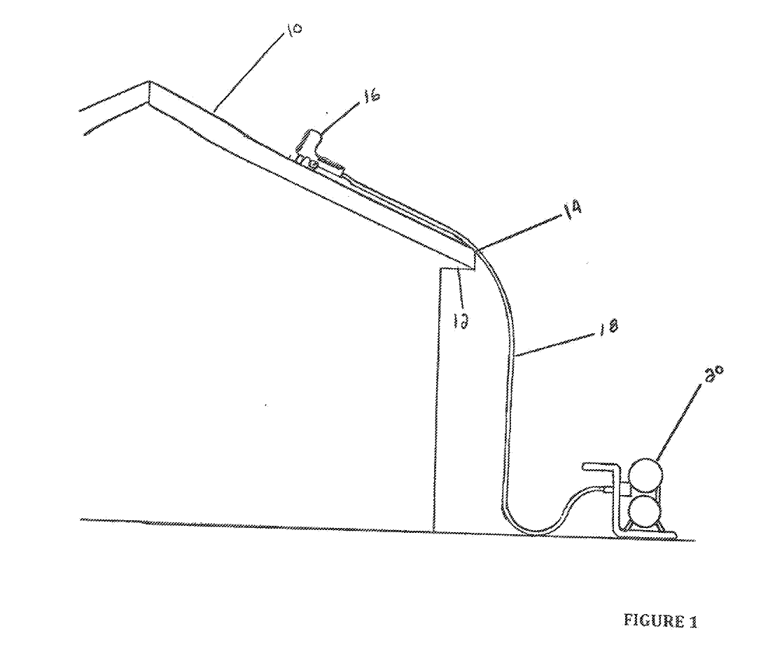

FIG. 2 is a perspective view, showing the movement of an air hose along an edge of a roof.

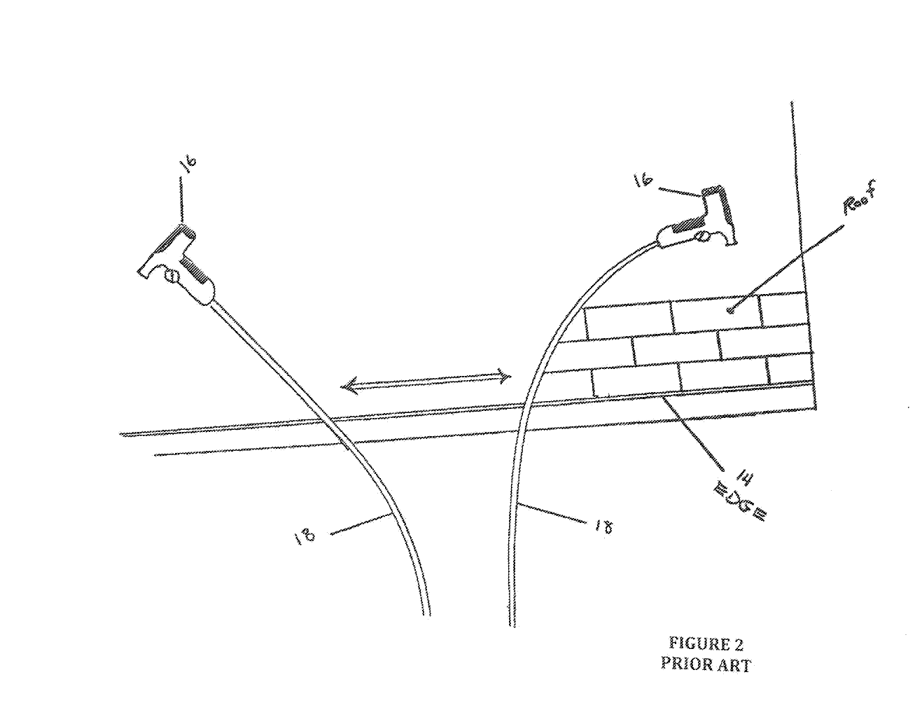

FIG. 3 is a perspective view, showing a first embodiment of the present invention.

FIG. 4 is a perspective view, showing the first embodiment from a different vantage point.

FIG. 5 is a perspective view, showing an air hose being loaded into the first embodiment.

FIG. 6 is a perspective view, showing the first embodiment in operation.

FIG. 7 is an elevation view, showing the first embodiment in operation.

FIG. 8 is a detail view, showing one type of base used in the present invention.

FIG. 9 is a perspective view, showing an alternate type of base.

FIG. 10 is a perspective view, showing an alternate embodiment designed to be placed on the peak of a roof.

FIG. 11 is a perspective view, showing an embodiment similar to the embodiment of FIG. 10 in operation.

FIG. 12 is a perspective view, showing an alternate embodiment for the gate.

FIG. 13 is a perspective view, showing an extendable mount for the pulley.

FIG. 14 is an elevation view, showing some representative hardware that is used in the invention.

FIG. 15 is a perspective view, showing an alternate embodiment that is configured to attach, directly to existing shingles.

REFERENCE NUMERALS IN THE DRAWINGS

| | | | |
|---|---|---|---|
| 10 | roof | 12 | eave |
| 14 | edge | 16 | nail gun |
| 18 | air hose | 20 | compressor |
| 22 | hose guide | 24 | base |
| 26 | pulley assembly | 28 | upright |
| 30 | gusset | 32 | pivot mount |
| 34 | bracket | 36 | pulley |
| 38 | axle | 40 | pin |
| 42 | clip | 44 | pivot joint |
| 46 | pin receiver | 48 | first lateral wall |
| 50 | second lateral wall | 52 | free hanging portion |
| 54 | roof portion | 56 | lanyard |
| 58 | slot | 60 | nail retainer |
| 62 | alternate base | 64 | outdoor carpet |
| 66 | nail hole | 68 | extension |
| 70 | apex base | 72 | first panel |
| 74 | second panel | 76 | opening |
| 78 | hinge | 80 | gate |
| 82 | latch | 84 | tab |
| 86 | adjustable upright | 88 | clip |
| 90 | hinge | | |

### DETAILED DESCRIPTION OF THE INVENTION

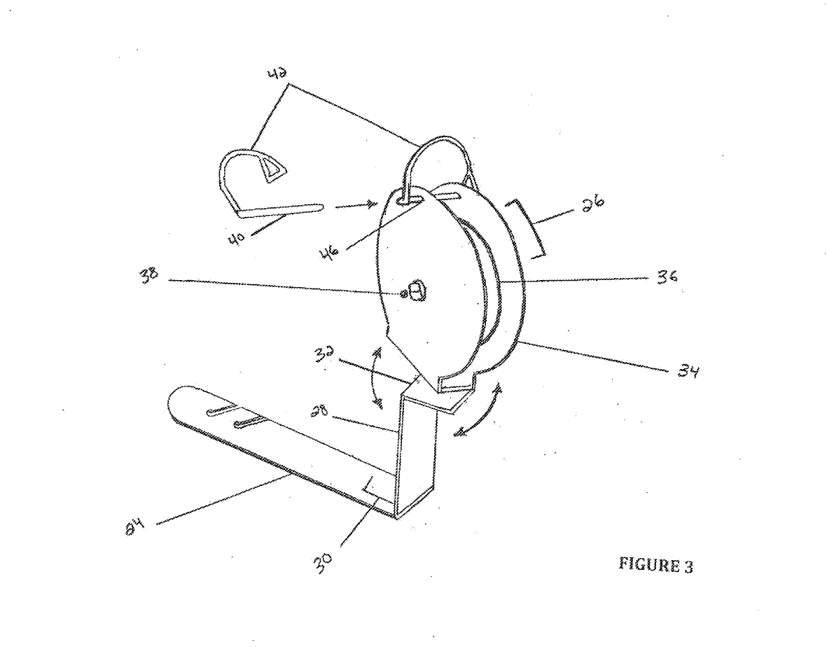

FIG. 3 shows a preferred embodiment of hose guide 22. The hose guide is designed to handle any long and flexible object which is suitably sized to fit through the device. It can, for example, accommodate air hoses, water hoses, and electrical cords. In the context of this disclosure, all these items will be referred to as “hoses.”

The two main components of hose guide 22 are base 24 and pulley assembly 26. Base 24 is configured to be attached to a roof, generally proximate the edge of the roof. Pivot mount 32 is attached to base 24. In the embodiment shown, it is separated from base 24 by upright 28. One or more gussets 30 are provided to reinforce the device.

Pulley assembly 26 is pivotally connected to pivot mount 32. It is free to pivot in the directions indicated by the double-headed arrow. Pulley 36 is mounted via axle 38. Axle 38 is attached to bracket 34—which includes a pair of lateral walls (one on each side of the pulley).

The upper portion of bracket 34 is open. The hose may be placed onto the pulley through this opening. However, in order to capture the hose within the hose, guide once it is installed, the opening may be selectively closed by sliding pin 40 into position. Pin 40 may include a spring-loaded clip 42. This clip retains the pin in position.

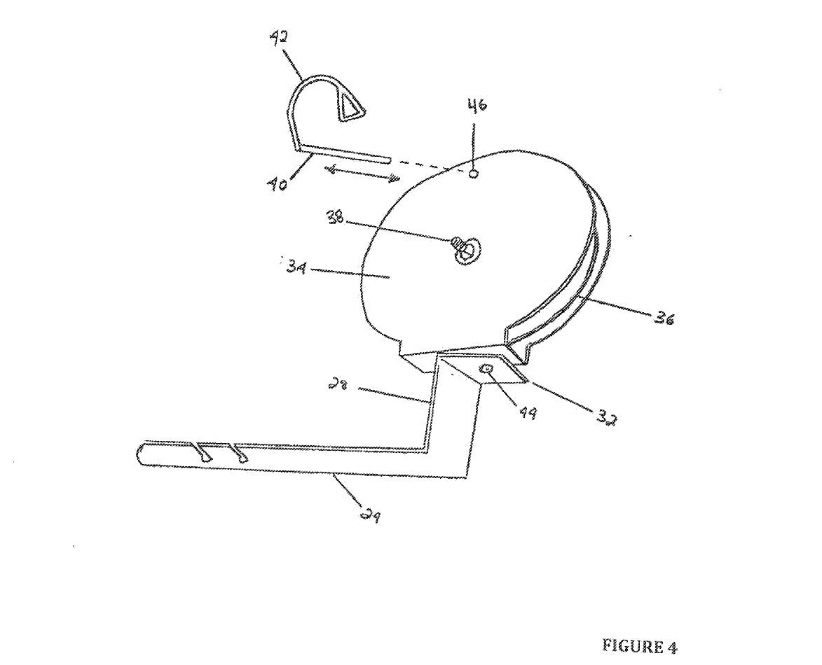

FIG. 4 shows hose guide 22 from another vantage point. Pivot joint 44 provides the pivoting connection between the pulley assembly and pivot mount 32. Any suitable hardware may be used for the pivot joint. As one example, a threaded stud and nut sandwiching two nylon washers may be used. As another example, a ball bearing may be pressed into position and retained by a nut.

FIG. 4 also shows pin 40 being removed to open the top of bracket 34. The reader will observe how bracket 34 includes pin receiver 46 passing therethrough. When the pin is pressed into the pin receiver, clip 42 may be flipped over the top of the pulley to retain the pin in place.

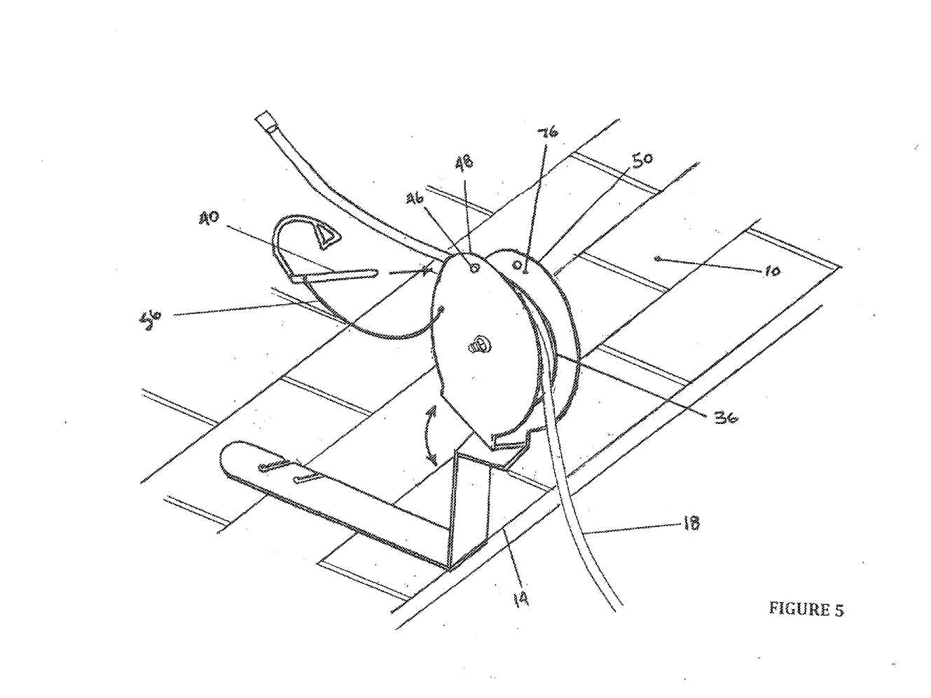

FIGS. 5-7 illustrate the process of installing a hose in the hose handler. In FIG. 5, the hose handler has been secured to the roof by passing two roofing nails through slots provided in the base. The hose handler, is positioned so that at least a portion of pulley 36 hangs out over edge 14. Pin 40 is removed, to expose the top opening in bracket 34. Pin 40 is preferably attached to some other portion of the hose handler by lanyard 56. If the pin is dropped the lanyard will not allow it to roll away.

The user places a portion of air hose 18 over pulley 36 by passing it through opening 76. The pulley preferably includes a semi-circular groove which seats the hose near the pulley's centerline. The user then closes opening 76 by pressing pin 40 back through pin receiver 46 in first lateral wall 48 and second lateral wall 50.

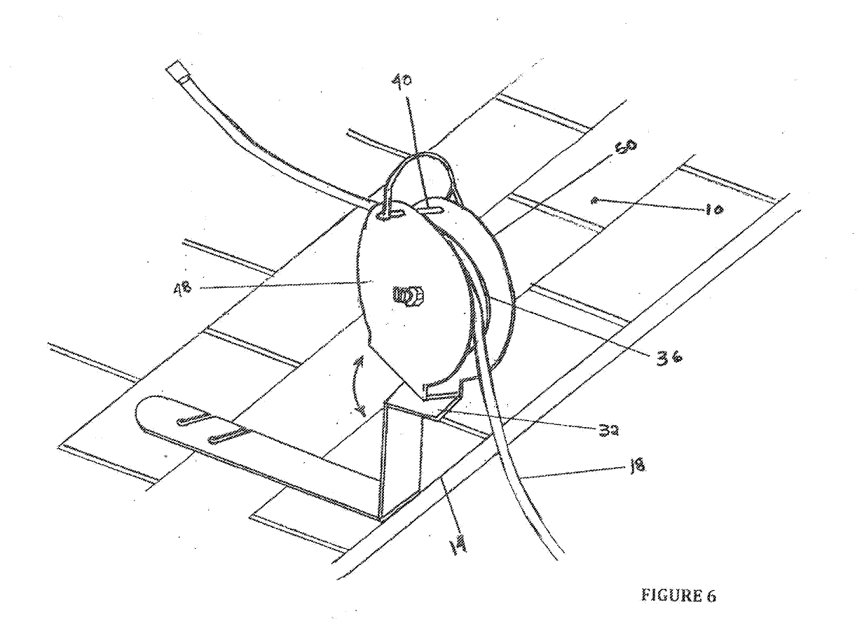

FIG. 6 shows the hose in position and retained by pin 40. If a user on the roof pulls on the hose, it will pass easily over pulley 36 and will not bear against the edge of the roof. Further, if a user on the roof moves laterally, the pulley assembly will pivot with respect to the base to accommodate this movement.

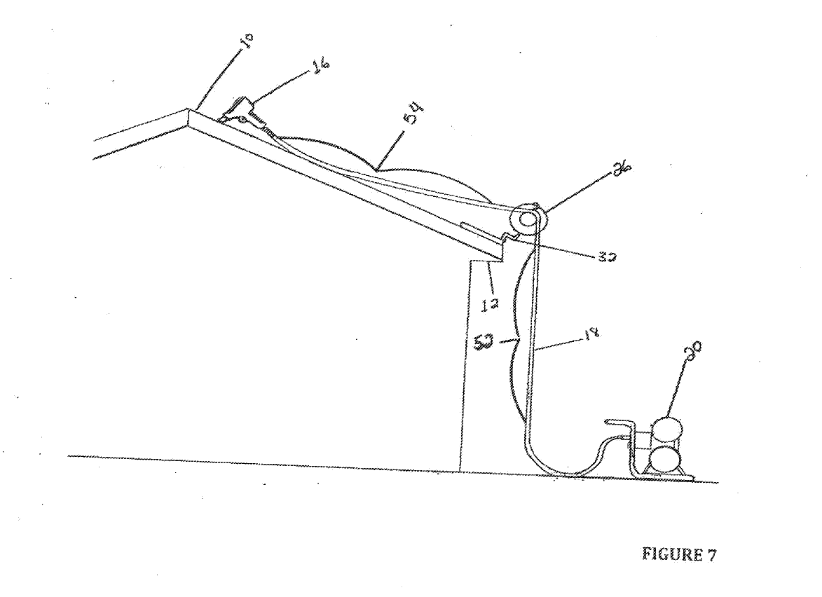

FIG. 7 shows an elevation view with air hose 18 locked into pulley assembly 26 (The portion of the hose passing through pulley assembly would not actually be visible. It is shown as solid lines in the view to aid visualization). The pulley divides the hose into two sections—free hanging portion 52 and roof portion 54. The suspended weight of the freer hanging portion provides a retraction function for the user. As the user moves closer to the pulley, the weight of the free hanging portion pulls some of the roof portion back through the pulley. As the user moves away from the pulley additional hose must be pulled up onto the roof. Thus, the hose handler naturally tends to minimize roof portion 54 and keep the hose in an organized state.

The placement of the hose handler is often significant to its operation. The reader will observe in FIG. 7 that the base has been installed to that pulley assembly 26 is well clear of edge 14. This goal is generally desirable.

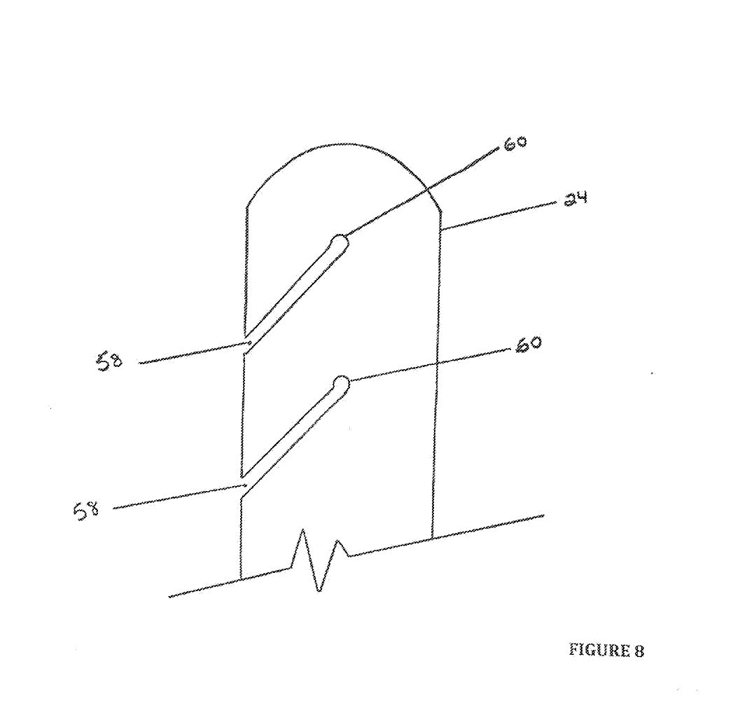

The base configurations used to attach the hose handler to the roof will now be discussed. FIG. 8 shows an embodiment of base 24 which is configured to be attached using roofing nails. This configuration is well known for the attachment of roofing devices. A pair of angled slots 58 are provided. Each of these includes a nail retainer as part of its closed end. The user places the hose handler in a desired position, then drives a nail through each nail retainer 60. The head of each roofing nail bears against the upper surface of base 24 and holds it in position. In order to subsequently remove the device, the user slides the base laterally so that the shafts of the two roofing nails pass through slots 58 (The user may have to pry the nails out slightly).

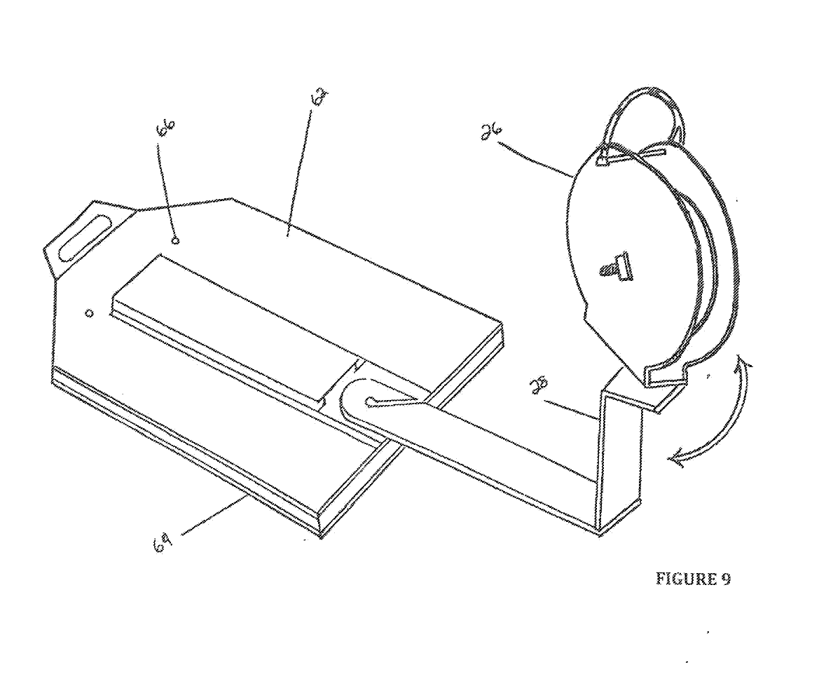

Other base configurations will be more suitable for other applications. FIG. 9 shows an alternate embodiment. Alternate base 62 is a large planar surface. Its downward-facing surface is covered in outdoor carpet 64. As is known to those skilled in the art, outdoor carpet sticks to asphalt shingles in a manner similar to hook-and-loop fasteners. Alternate base 62 may therefore maintain its position without the need for any fasteners. The use of outdoor carpet is only one example, as many other coverings may be used to grip asphalt shingles.

A different base may well be needed for a different type of roof. In the case of a metal roof, it is desirable to provide a base that includes one or more strong magnets. The magnet will stick the base to a metal roof. As shown in FIG. 9, it is possible to make the base and the pulley assembly as two separate components which may be selectively linked. In the embodiment of FIG. 9, the link is made by providing a sliding pocket in the base. This receives a corresponding portion that is attached to the pulley assembly. In this fashion, a single pulley assembly may be provided with multiple bases for use in differing roofing environments.

The length of extension 68 may be varied to separate upright 28 sufficiently beyond the edge of the roof. Nail holes 66 may be provided in the base in case the user wishes to add one or more nails through the base for additional security.

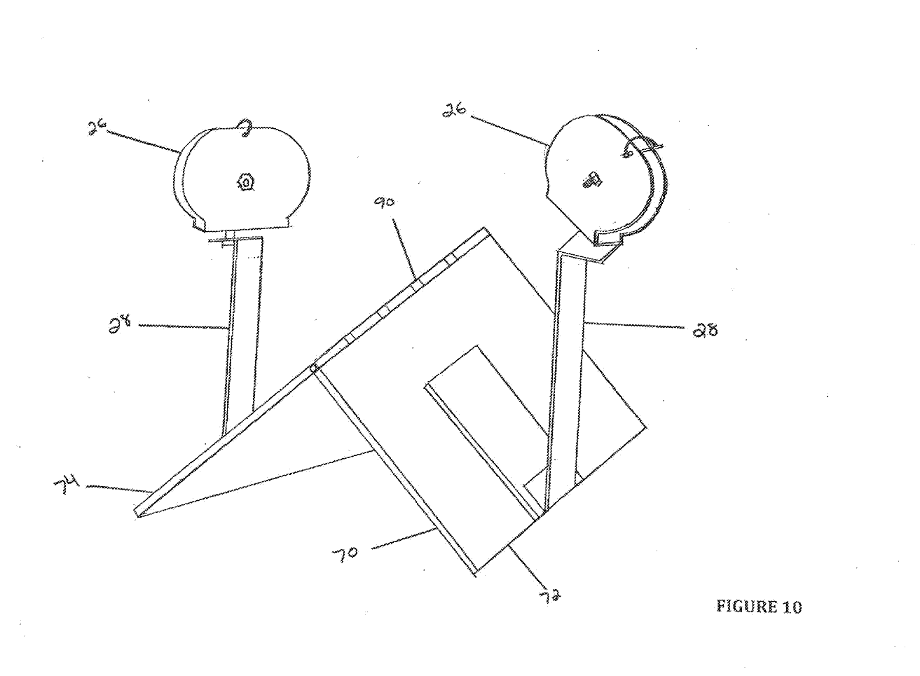

Special bases may be used for locating pulley assemblies near other particular roof structures. FIG. 10 shows apex base 70, which is configured to rest on the peak of a roof. It includes first panel 72 and second panel 74. The angle between these two panels may be made adjustable in order to account for different roof pitches. They may even be joined by hinge 90 so that the angle is variable.

In the particular embodiment of FIG. 10, two pulley assemblies 26 are shown. Roofing crews often have two or more nail gun operators working simultaneously. It may therefore be advantageous to provide safe routing for two or more air hoses. The pulley assemblies are separated from the base as desired—such as by using uprights 28. The embodiment of FIG. 10 uses two pulley assemblies to accommodate two air hoses. Alternatively, multiple parallel pulleys could be provided in a single pulley assembly.

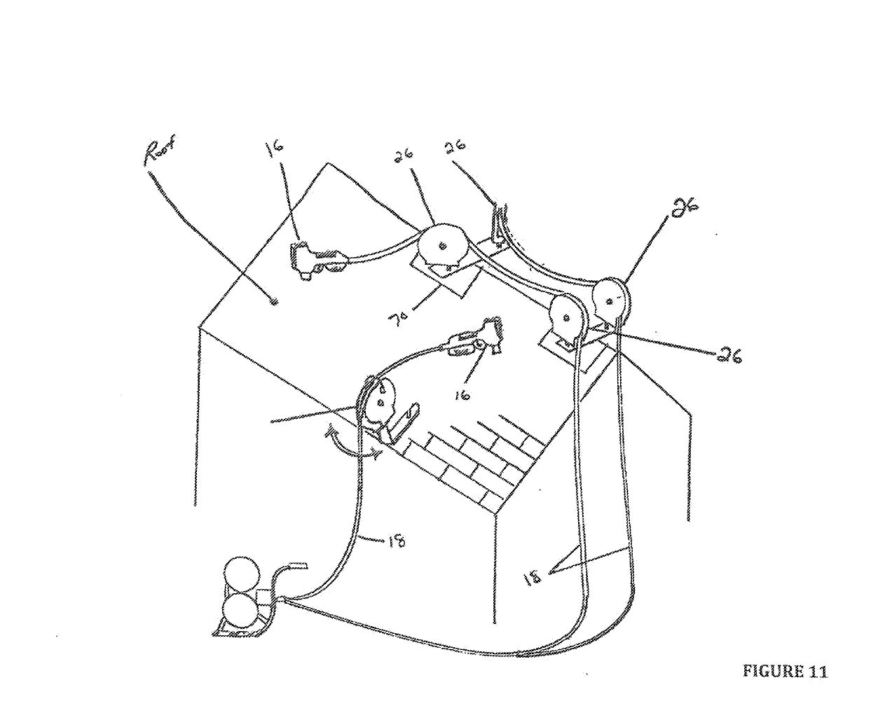

FIG. 11 shows an altered version of apex base 70 in position on the peak of a roof. In this version, each apex base mounts a pair of pulley assemblies 26 pivoting on a common pivot. The reader should appreciate that numerous specialized hose handlers could be placed around a large roof to handle the required air hoses.

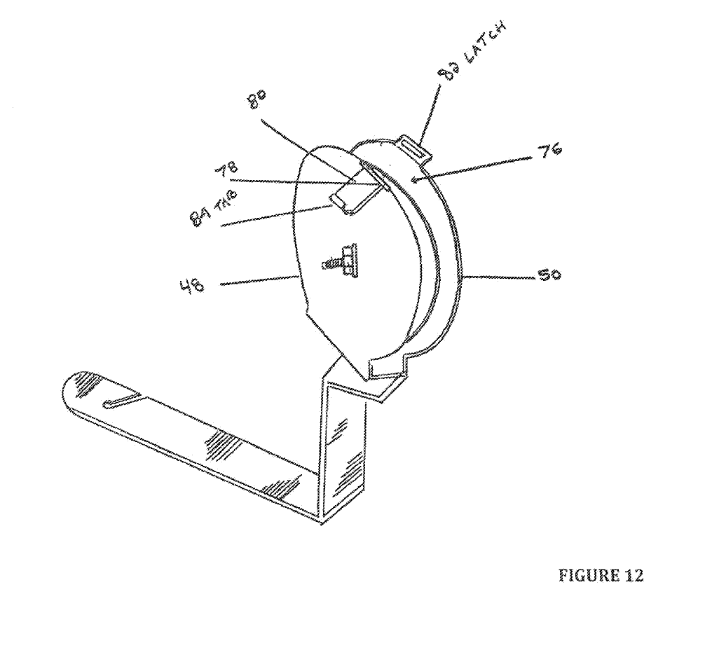

FIG. 12 shows an alternate embodiment of the gate. While the removable pin shown for the prior embodiments works satisfactorily, it may be difficult to operate with one hand. Gate 80 is easier to operate with one hand. Gate 80 has a first end which is pivotally connected to first lateral wall 48 by hinge 78. The second end of gate 80 is selectively latched to second lateral wall 50 by latch 82. In the embodiment shown, latch 82 is simply a magnet. Gate 80 is made of ferromagnetic material and it is held by the magnet in the closed position. Tab 84 is provided to assist the user in pulling gate 80 away from the magnet.

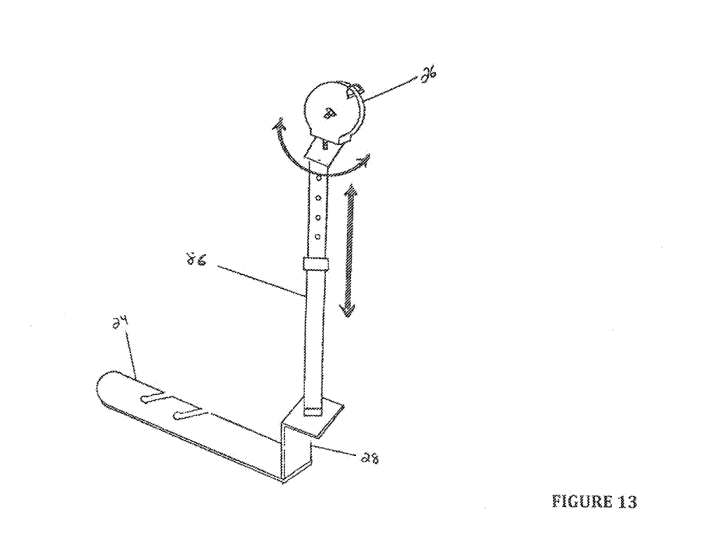

FIG. 13 shows an embodiment in which the separation between the pulley assembly 26 and base 24 is made adjustable. Adjustable upright 86 features a female receiver with a telescoping male component. A cross pin or other suitable device is used to set the desired length of extension.

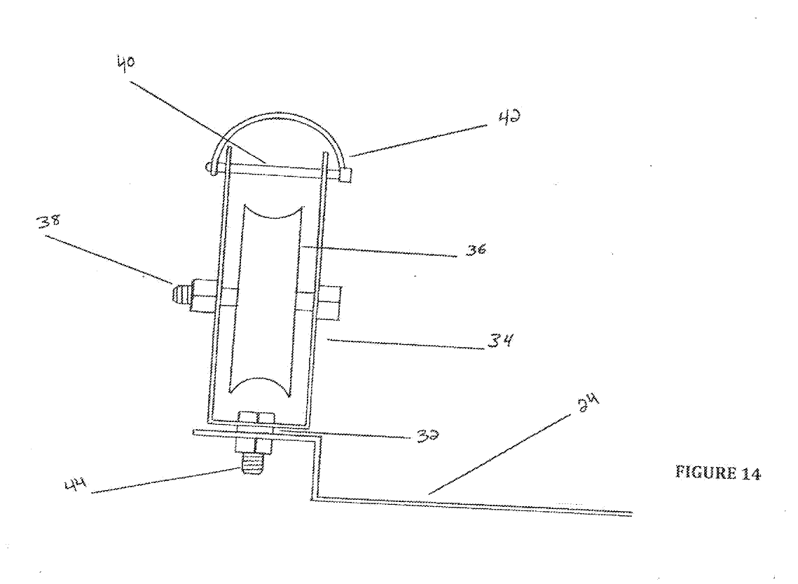

FIG. 14 shows an elevation view of an embodiment similar to the one shown in FIG. 3. The reader will observe how pulley 36 rotates about axle 38. The reader will also observe how pivot joint 44 is perpendicular to axle 38.

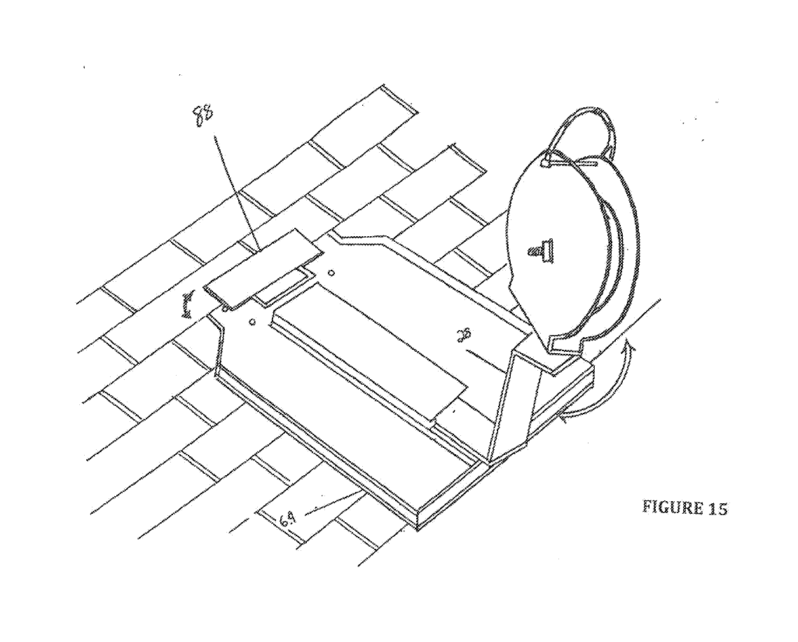

FIG. 15 shows still another embodiment for the base. The frictional engagement between outdoor carpet 64 and the asphalt shingles of the roof provides a reasonable level of security for the device. However, this may be insufficient to prevent unwanted motion. Clip 88 provides additional security. Clip 88 is preferably a spring-loaded clip such as found at the top of a conventional clip-board. The user attaches clip 88 to the exposed edge of one or more roofing shingles. This further secures the invention in place.

Some of the terms used in this specification have explicitly been given definitions which may be broader than those customarily used. As mentioned previously, the term “hose” is defined to include electrical cords and other long and flexible items. Likewise, the term “roof” is defined to mean any surface on which construction work might typically be performed—provided that the surface has an edge over which a hose needs to be passed.

Some roofs are flat. The hose handler is advantageous in these cases as well as for pitched-roof construction. Using the definition provided, a “roof” also encompasses the second floor of a building under construction. Hoses must be passed from the ground over the edge of a second floor as well, and the hose handler is equally advantageous for these situations.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the claims presented, rather than by the examples given.

Having described my invention, I claim:

1. A method for passing a hose over an edge of a roof, said edge being elevated above the ground, comprising:
a. providing a hose guide, including
i. a base,
ii. a pivot mount attached to said base,
iii. a pulley assembly pivotally connected to said pivot mount,
iv. said pulley assembly including a pulley,
v. said pulley assembly including a top opening providing access to said pulley, wherein said top opening is selectively closed by a gate;
b. placing said base on said roof proximate said edge, in an orientation where at least a portion of said pulley extends outward away from said roof and beyond said edge;
c. opening said gate;
d. placing said hose over said pulley by passing a portion of said hose through said top opening; and
e. closing said gate.

2. A method for passing a hose over an edge as recited in claim 1, wherein:
a. said top opening is defined by a gap between a first lateral wall on a first side of said pulley and a second lateral wall on a second side of said pulley;
b. said first and second lateral walls include a pin receiver passing laterally therethrough; and
c. said gate comprises a pin which is selectively placed in said pin receiver to close said top opening.

3. A method for passing a hose over an edge as recited in claim 1, wherein:
a. said top opening is defined by a gap between a first lateral wall on a first side of said pulley and a second lateral wall on a second side of said pulley;
b. said gate has a first end and a second end;
c. said first end of said gate is pivotally connected to said first lateral wall; and
d. said second end of said gate is selectively latched to said second lateral wall.

4. A method for passing a hose over an edge as recited in claim 1, wherein said latch between said second end of said gate and said second lateral wall is a magnet.

5. A method for passing a hose over an edge as recited in claim 1, wherein said base is a planar surface including a downward-facing piece of outdoor carpet.

6. A method for passing a hose over an edge as recited in claim 1, wherein said base includes at least one lateral slot configured to receive a roofing nail.

7. A method for passing a hose over an edge as recited in claim 1, wherein:
a. said top opening is defined by a gap between a first lateral wall on a first side of said pulley and a second lateral wall on a second side of said pulley;
b. said gate is pivotally connected to said first lateral wall; and
c. said gate can be selectively latched in a closed position whereby said gate closes said top opening.

8. A method for passing a hose over an edge of a roof, said edge being elevated above the ground, comprising:
a. providing a hose guide, including
i. a base,
ii. a pivot mount attached to said base,
iii. a pulley assembly pivotally connected to said pivot mount,
iv. said pulley assembly including a pulley;
v. said pulley assembly including an opening providing access to said pulley, wherein said opening is, selectively closed by a gate;
b. securing said base to said roof proximate said edge, in an orientation where at least a portion of said pulley extends outward away from said roof and beyond said edge;
c. placing said hose over said pulley; and
d. closing said gate to secure said hose.

9. A method for passing a hose over an edge as recited in claim 8, wherein:
a. said opening is defined by a gap between a first lateral wall on a first side of said pulley and a second lateral wall on a second side of said pulley;
b. said first and second lateral walls include a pin receiver passing laterally therethrough; and
c. said gate comprises a pin which is selectively placed in said pin receiver to close said opening.

10. A method for passing a hose over an edge as, recited, in claim 8, wherein:
a. said opening is defined by a gap between a first lateral wall on a first side of said pulley and a second lateral wall on a second side of said pulley;
b. said gate has a first end and a second end;
c. said first end of said gate is pivotally connected to said first lateral wall; and
d. said second end of said gate is selectively latched to said second lateral wall.

11. A method for passing a hose over an edge as recited in claim 8, wherein said latch between said second end of said gate and said second lateral wall is a magnet.

12. A method for passing a hose over an edge as recited in claim 8, wherein said base is a planar surface including a downward-facing piece of outdoor carpet.

13. A method for passing a hose over an edge as recited in claim 8, wherein said base includes at least one lateral slot configured to receive a roofing nail.

14. A method for passing a hose over an edge as recited in claim 8, wherein:
a. said opening is defined by a gap between a first lateral wall on a first side of said pulley and a second lateral wall on a second side of said pulley;
b. said gate is pivotally connected to said first lateral wall; and
c. said gate can be selectively latched in a closed position whereby said gate closes said opening.

15. A method for passing a hose over an edge of a roof, said edge being elevated above the ground, comprising:
a. providing a hose guide, including
i. a base,
ii. a pivot mount attached to said base,
iii. a pulley assembly pivotally connected to said pivot mount,
iv. said pulley assembly including a pulley,
v. said pulley assembly including an opening providing access to said pulley,
vi. said pulley assembly including a gate positioned to selectively close said opening;
b. placing said base on said roof proximate said roof;
c. opening said gate;
d. placing said hose over said pulley by passing a portion of said hose through said opening; and
e. closing said gate.

16. A method for passing a hose over an edge as recited in claim 15, wherein:
a. said opening is defined by a gap between a first lateral wall on a first side of said pulley and a second lateral wall on a second side of said pulley;
b. said first and second lateral walls include a pin receiver passing laterally therethrough; and
c. said gate comprises a pin which is selectively placed in said pin receiver to close said opening.

17. A method for passing a hose over an edge as recited in claim 15, wherein:
a. said opening is defined by a gap between a first lateral wall on a first side of said pulley and a second lateral wall on a second side of said pulley;
b. said gate has a first end and a second end;
c. said first end of said gate is pivotally connected to said first lateral wall; and
d. said second end of said gate is selectively latched to said second lateral wall.

18. A method for passing a hose over an edge as recited in claim 15, wherein said latch between said second end of said gate and said second lateral wall is a magnet.

19. A method for passing a hose over an edge as recited in claim 15, wherein said base is a planar surface including a downward-facing piece of outdoor carpet.

20. A method for passing a hose over an edge as recited in claim 15, wherein said base includes at least one lateral slot configured to receive a roofing nail.
